(19) United States
(12) Patent Application Publication
(10) Pub. No.: US 2018/0331598 A1
(43) Pub. Date: Nov. 15, 2018

(54) MASS TURBINE AND ELECTRIC GENERATORS

(71) Applicant: Camelito TIANCHON, New York, NY (US)

(72) Inventor: Camelito TIANCHON, New York, NY (US)

(21) Appl. No.: 15/732,354

(22) PCT Filed: May 10, 2017
(86) PCT No.: PCT/US2017/000031

§ 371 Date: Oct. 27, 2017

(51) Int. Cl. H02K 7/18; F03G 3/00

(52) U.S. Cl. CPC H02K 7/1853; H02K 53/00; F03G 3/00

(57) ABSTRACT

A baseload, fuelless and gearbox-free renewable 100; wherein the turbine with exponential energy gain 130 converts its predetermined mass into a stored kinetic energy that powers the generator, the generator comprises at least a vertical-axis armature 140 and stators 150, which temporarily abrogates Lenz's Law while its large and massive rotor instead driven by small motors—thereby created an exponentially efficient renewable which addresses: energy security, climate change, conversion of desert lands . . . ; given that large percentage of the electricity remained deliverable, the so-called “exponential energy gain” is in effect analogous to an exponential saving and relatively a greater return on investment; potentially it operates 24/7 despite the extreme weather conditions: drought, storm, etc.

### CROSS-REFERENCE TO RELATED APPLICATIONS

This application relates to the Related Invention as described and claimed by the U.S. Pat. No. 8,878,382 B2, issued Nov. 4, 2014 and Provisional Application No. 62/391,981 filed May 16, 2016.

This application also relates to PCT/US2016/045418, filed Aug. 3, 2016, which I intend to abandon and replace, in particular, the replacement herein consolidates the previously filed claims with the new and/or amended claims but without new matter; wherein a mass turbine is configured coaxially with a new kind of direct drive generator.

The following is a copy of the said U.S. patent, which has been amended and upgraded, and wherein the drawings and the description of the said Related Invention are shown and described following the heading, “RELATED INVENTION”.

### FIELD OF THE INVENTION

This present invention generally relates to the field of power generation. In particular, this present invention is directed to a mass turbine and electric generators, wherein the said turbine converts a predetermined mass into a stored kinetic energy that eventually drives the generator to generate electricity; and wherein a small amount of the electricity is used to power the motors that drive the turbine . . . while large amount of the electricity is send to the grid—thereby created a baseload, fuelless and gearbox-free renewable that addresses: energy security, climate change . . . and operates 24/7 despite the extreme weather conditions: rain, snow, typhoon or drought.

The turbine which enabled the so-called “exponential energy gain” is named “mass turbine”, a unique name in comparison to a flywheel, wind turbine, gas turbine, etc., which distinctively defined its presence in the marketplace.

The mass turbine which enabled the so-called “exponential energy gain” is analogous to “a hydropower station”, wherein both are: equipped with a direct drive generator, baseload capable and emission free. But they differ on environmental issue, on footprint in particular.

The mass turbine which enabled the so-called “exponential energy gain” is also analogous to “an oil rig”, wherein the energy output are like gifts from nature. The mass turbine however, is clean and practically inexhaustible.

Industry like: aluminum, cement, desalination . . . will find this transformational turbine inevitable, at least, as a major cost-cutting solution.

### BACKGROUND OF THE INVENTION

For many years the world has been engaged and exploited, quite every natural resources in the planet, in search for alternative energy. Yet, it appears that old science facts, which are so obvious . . . were taken for granted.

From his writing, century ago, Albert Einstein had said that “mass and energy are equivalent . . . ”. It is obvious for those skilled in the art that mass in motion generates kinetic energy.

Those moving trucks and cars down the road . . . are untapped energies and the economy should be better off by having the means and connect those to the grid. That of course . . . is a wishful thinking.

But a high density mass of the right configuration is positively a reliable energy. It is clean and potentially inexhaustible.

### PRIOR ART

There has been a popular understanding that, in a real machine, “the output . . . is less than the input . . . ”, which is true, and yet, it is somehow short sighted.

It is true on all kind of machines we have had experienced of . . . specifically on power plants. It is true on prior power plants, partly due to the physical phenomena also known as Lenz's law. In addition, much of the energy on prior power plant unfortunately transformed into heat and dissipates—thereby the output is always less . . . and in all cases the output is far below the desirable 100% efficiency.

Surprisingly, this popular understanding is also short sighted. It is short sighted because on a larger-scale, the math had shown that we could also configure a machine, wherein the output is greater or exponentially greater per unit of (revolution per minute) rpm or moment.

Take for example the physics on a simple machine, in particular, a “lever” with significant amount of leverage . . . .

### Exponential Energy Gain

Further the idea of a turbine with “exponential energy gain” is still under development. Again, based on the conventional engineering practiced, that seems to contradict with the laws of Physics and the world had no experienced with this kind of machine ever, however, the following scenarios may further shed some lights.

You may had watched a building under construction lately, in particular, had noticed a steel beam which at the midpoint tied to a cable and horizontally suspended in the mid-air by a crane, and with almost no friction, makes it easily rotates about the cable.

Quite open, you may notice a person with his bare hand pulls or pushes the beam as he assemble the structure seemingly with ease.

Technically, as the person pulls and pushes the beam, he applied a force, known in Physics as, F=ma but rather in angular momentum, F=m(v²/r), which either one is a lineal equation.

Correspondingly, as the beam moves along it generates a kinetic energy. The equation for kinetic energy is exponential, in this case, E=½mr²(v/r)², which indicates that its potential kinetic energy is either less or more than the applied force relative to the length of the beam, for now, assumed that the beam has a high density mass on both ends.

Similarly and given a rotor of different sizes—from small to a very large in diameter, mathematically the graph of the two equations (not shows) illustrate the relation of two lines, namely: a parabola for energy and a slope for force; wherein the parabola which starts quite below the slope but as the graph progresses more to the right . . . the parabola correspondingly goes exponentially upward and towering over the slope, which again it indicate that a turbine of the right configuration, “an exponential energy gain” is profoundly achievable—more on Mechanics later in this specification.

### Objective

Knowing that an exponential energy gain is achievable, it is therefore the object of the present invention to provide a mass turbine that converts a predetermined mass into a stored kinetic energy, and used much of that energy to drive a generator to generate electricity, and essentially make it Self-sustaining.

### SUMMARY OF THE INVENTION

A renewable of the present invention comprises: an enclosure, a rotor with exponential energy gain, and electric generator; wherein the rotor is driven by an initiator drive equipped with small motors connected to a power.

### An Enclosure

An enclosure could either: a building, an offshore structure or a large ocean-going vessel, wherein the enclosure comprises at least: a bottom floor, a peripheral upright member, and a ceiling. Said ceiling is defined as a predetermined horizontal plane aligned with the upper-end of the rotor, and preferably a space is created in between the ceiling and the floor above or equivalent.

Preferably an enclosure is provided with at least one intermediate floor, wherein a space is created in between the intermediate floor and the bottom floor, and another space in between the intermediate floor and the ceiling. Also much preferred is an access space created below the bottom floor where the floor pivotal assembly is installed.

Both the bottom floor and intermediate floor are also known as the stationary lateral members or stationary transverse members. In some application, a stationary member could be a plain concrete on the ground or any suitable structure.

### A Rotor with Exponential Energy Gain

The present invention essentially features a vertical-axis rotor. Circumferentially a vertical-axis rotor is equidistant to the horizontal plane or earth's center of gravity, and wherein the centripetal forces at any point peripherally are all mathematically positive.

A rotor with exponential energy gain comprises: a vertical shaft member and a plurality of lateral lever members. Said vertical shaft member is defined at least as a rigid cylindrical member having an upper and lower ends and held pivotal by means about a predetermined vertical axis of rotation in said enclosure.

Each lateral lever member is defined at least as an elongated rigid member having a mountable and effort ends, wherein the mountable end is attached laterally to a predetermined point on the said vertical shaft member. The effort end is configured with a predetermined high density point mass or mass assembly, wherein the high density point mass or mass assembly is disposed to a predetermined effective horizontal path in space about the vertical axis of rotation, and wherein the high density point mass or mass assembly enable the said rotor achieved an output energy in quantity greater than the required input energy per unit of velocity.

### An Initiator Drive System

The said input energy which includes a force to cancel potential frictions is a relatively small input force applied to the said rotor by an appropriate initiator drive system. The said initiator drive comprises at least: a rim member, a plurality of lateral spoke member, and plurality of space apart stationary drive assemblies, and wherein each lateral spoke member is configured with a mountable and effort ends.

The said mountable end is attached laterally to the vertical shaft member, and oppositely the effort end is disposed to a predetermined effective horizontal path in space about the vertical axis of rotation and attached to the rim, wherein the lateral spoke members and rim member unitary defined a wheel assembly, and wherein the wheel assembly peripherally encloses the lateral lever members.

Each stationary drive assembly is attached to the respective peripheral upright of the enclosure and at least supporting the wheel assembly. Each stationary drive is powered by a small motor connected to a power, and wherein the stationary drive is configured such that it drives the wheel assembly and eventually the lateral lever members about the vertical axis of rotation, that finally generates a torque on the vertical shaft.

Given that the turbine consumed just a small amount of electricity it produced, and the remaining large amount is send to the grid, the so-called “exponential energy gain” is in effect analogous to “an exponential saving and building a prosperous economy”.

### BRIEF DESCRIPTION OF THE DRAWINGS

FIG. 1, an elevation view of an enclosure in the form of a building with a cut-out showing the partial view of the turbine, according to the present invention;

FIG. 2, a section thru line 2-2 of FIG. 1;

FIG. 3, an enlarged partial view at point 3 of FIG. 2;

FIG. 4, an enlarged partial view of FIG. 2;

FIG. 5, a further enlarged view at point 5 of FIG. 4;

FIG. 6, an alternate detail of the spoke members of FIG. 4;

FIG. 7, another alternate detail of spoke and lever members of FIG. 4;

FIG. 8, a cross section view thru line 8-8 of FIG. 2;

FIG. 9, an enlarged partial view at point 9 of FIG. 8;

FIG. 10, an enlarged view at point 10 of a mass assembly 68 of FIG. 9;

FIG. 11, a section view thru line 11-11 of FIG. 10;

FIG. 12, an enlarged partial view at point 12 of FIG. 8;

FIG. 13, an enlarged partial view at point 13 of a stationary drive assembly 70 of FIG. 12;

FIG. 14, an enlarged partial view at point 14 of FIG. 8;

FIG. 15, an enlarged partial view at point 15 of FIG. 14;

### Related Invention

FIG. 16, is a cross section view of the turbine and direct drive generator;

FIG. 17, is a plan of the generator through line 17-17, of FIG. 16;

FIG. 18, is an enlarged partial view at point 18, of FIG. 16;

FIG. 19, is an enlarged partial view at point 19, of FIG. 16;

FIG. 20, is an enlarged partial view at point 20, of FIG. 16;

FIG. 21, is an enlarged partial view at point 21, of FIG. 16;

FIG. 22, is an enlarged view at point 22 of FIG. 17; and

FIG. 23, is an alternative inductor assembly.

### ILLUSTRATIVE EMBODIMENT

Accordingly the invention will now be described, by way of example, with reference to the accompanying drawings and equations, in which:

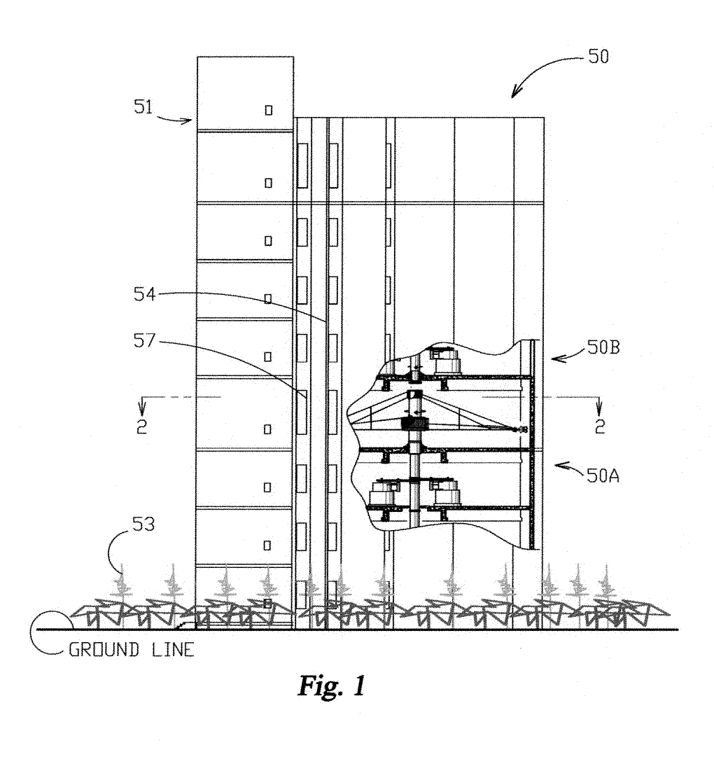

FIG. 1, is the elevation view of an illustrative embodiment, an enclosure in the form of a building 50, with a cut-out view of the interior of the turbines 50A and 50B. The building further has an optional service space 51 and optional plants or trees 53.

### An Enclosure

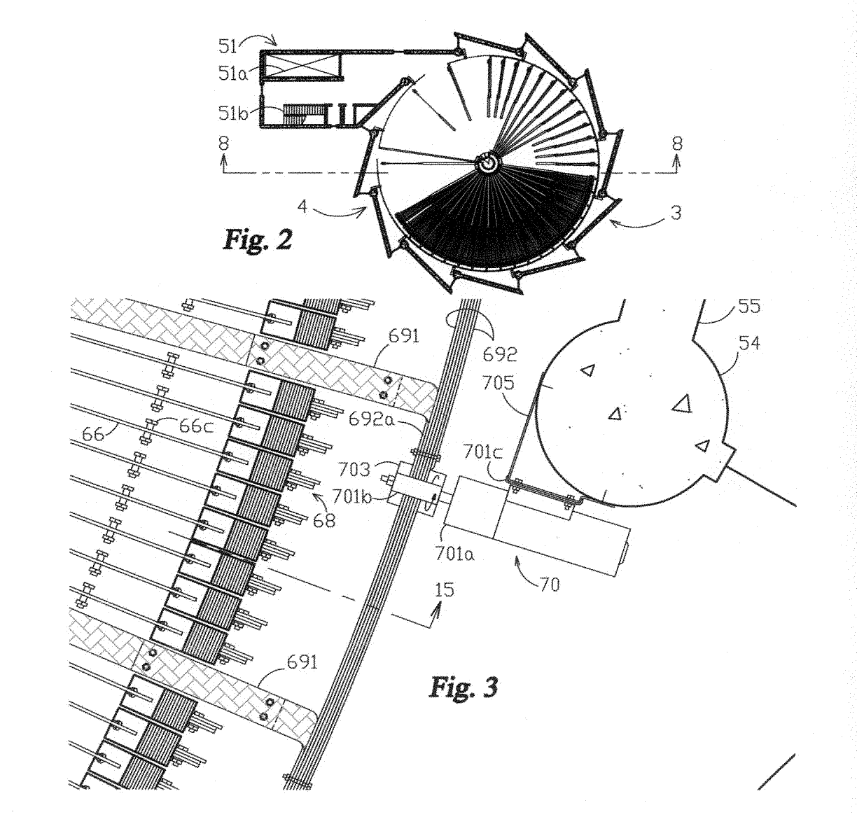

FIGS. 2, 3 and 4 are layouts of the building 50 in particular; the said enclosure comprises a plurality of space-apart columns 54, walls 55, and said optional service space 51 that houses an elevator 51a, and stair 51b.

The said columns 54 are made of concrete or equivalent and respectively measured from a predetermined common point, also known as the vertical axis of rotation.

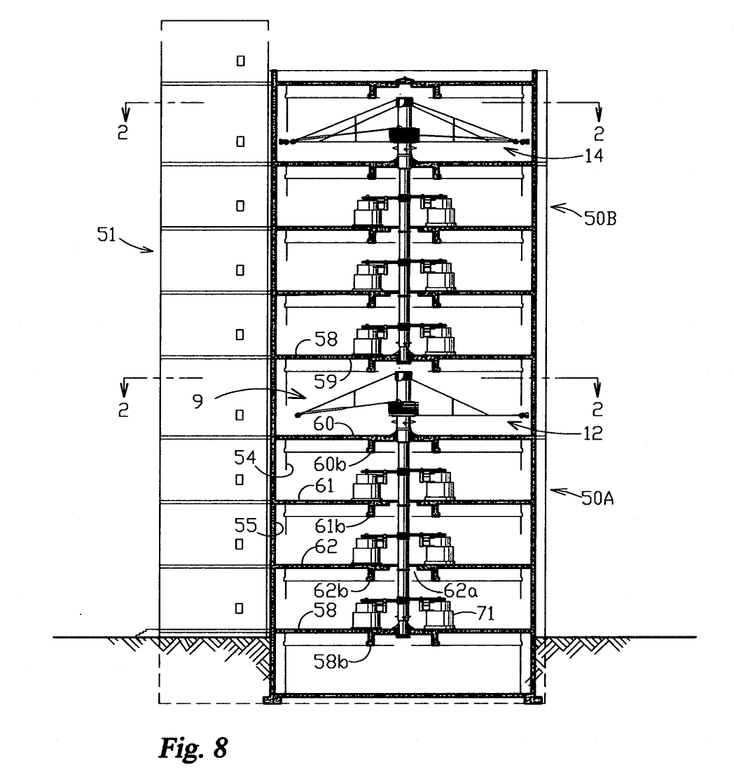

FIGS. 8, 9 and 12, wherein said column 54 and wall 55 are shown with the bottom floor 58, a ceiling, a roof or top member 59, and an intermediate floor 60, wherein said bottom 58 and intermediate floor 60 are respectively provided with pivotal means 64, and 65, and wherein said pivotal means are disposed coaxially with said vertical axis of rotation.

In some application, the roof is either directly connected to or detached from wall 55 or column 54 but at least it has to protect the system from the elements such as rain or snow.

As mentioned previously, said ceiling is defined as a predetermined horizontal plane which is aligned with the upper-end of the rotor. The space in between the upper-end of the rotor and top member 59 is defined as an access space, wherein said access space is to facilitate the installation and future maintenance of the pivotal means, also known as a floor pivotal assembly of the other unit above, FIG. 8.

Additional intermediate floors 61, and 62, with respective shaft raceway 61a, 62a, are coaxially provided, FIG. 8. And as mentioned previously, said floors or at least the said intermediate floor 60 is defined by the size of a predetermined space wherein it enable the said rotor achieved its potential energy gain.

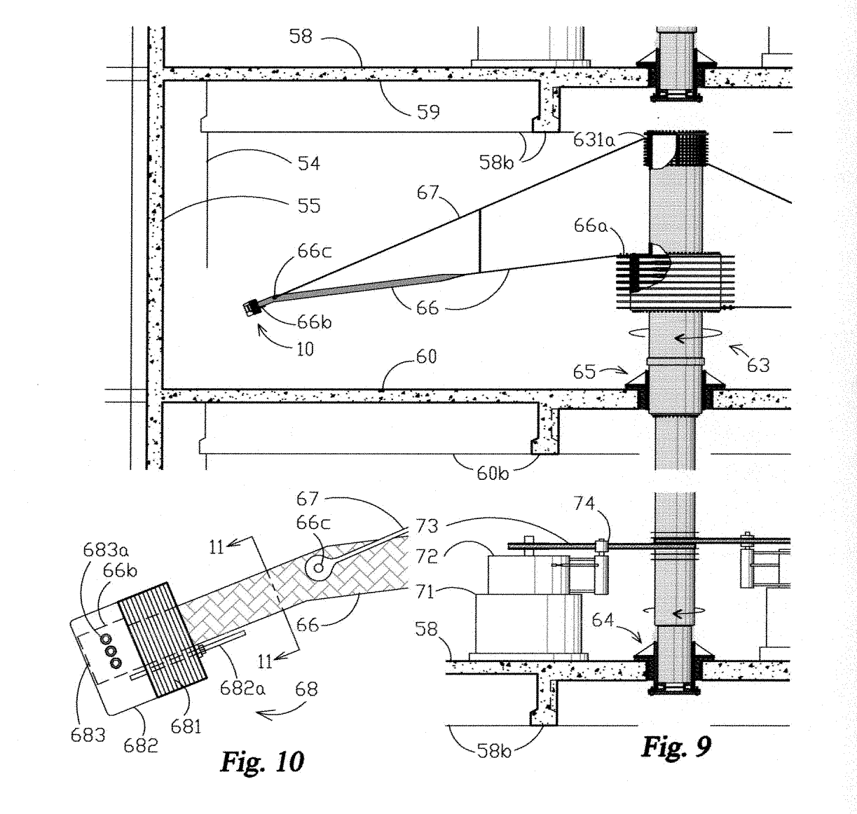

The floors are made of concrete or equivalent and are provided with optional beam members 58b, 59b, 60b, 61b, and 62b, disposed respectively in between the respective said columns 54, FIGS. 8 and 9. Alternately, the said beam members may be replaced by intermediate columns (not shown) if desirable.

### A Rotor with Exponential Energy Gain

FIG. 8 is a section view thru line 8-8 of FIG. 2. A building 50, comprises of turbines 50A and 50B, wherein the turbines are configured one above the other to illustrate on how the present invention may optimized the value of a parcel of land, particularly in the urban area.

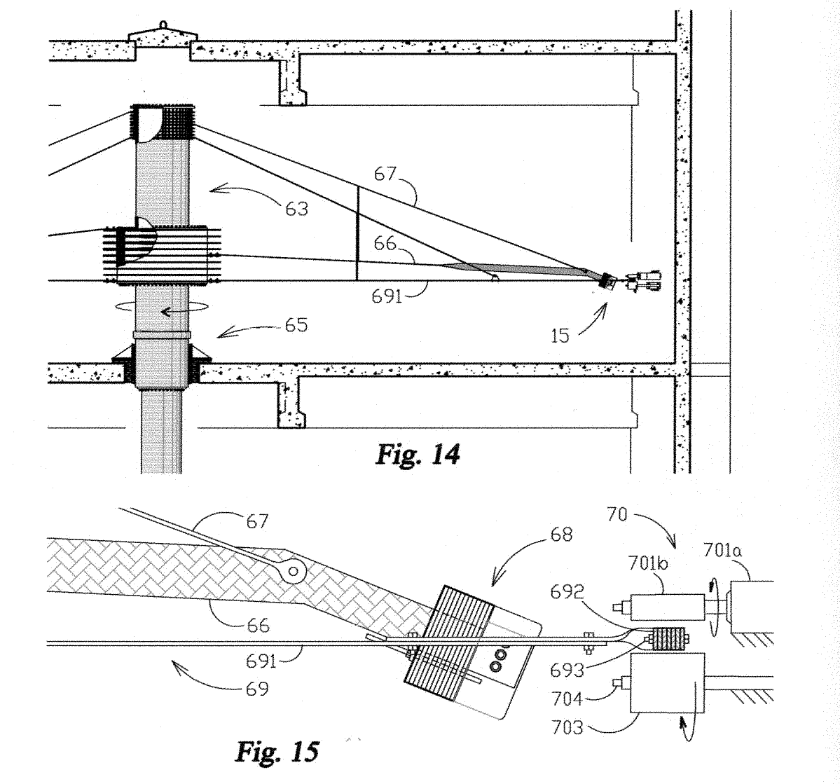

FIGS. 9, 12 and 14, are enlarged views of the turbine in particular a rotor comprises a vertical shaft member 63, and a plurality of lateral lever members 66. The said vertical shaft member 63 has an upper-end and lower-end and unitary held by a pair of pivotal means or floor pivotal assembly 64, and 65.

The vertical shaft member 63 is further defined by its capacity to hold the said lateral lever members 66 in placed and able to transfer the required torque: regardless of its configuration, regardless of the kind of mounting means employed, regardless of the kind of material but within the scope and spirit of the present invention.

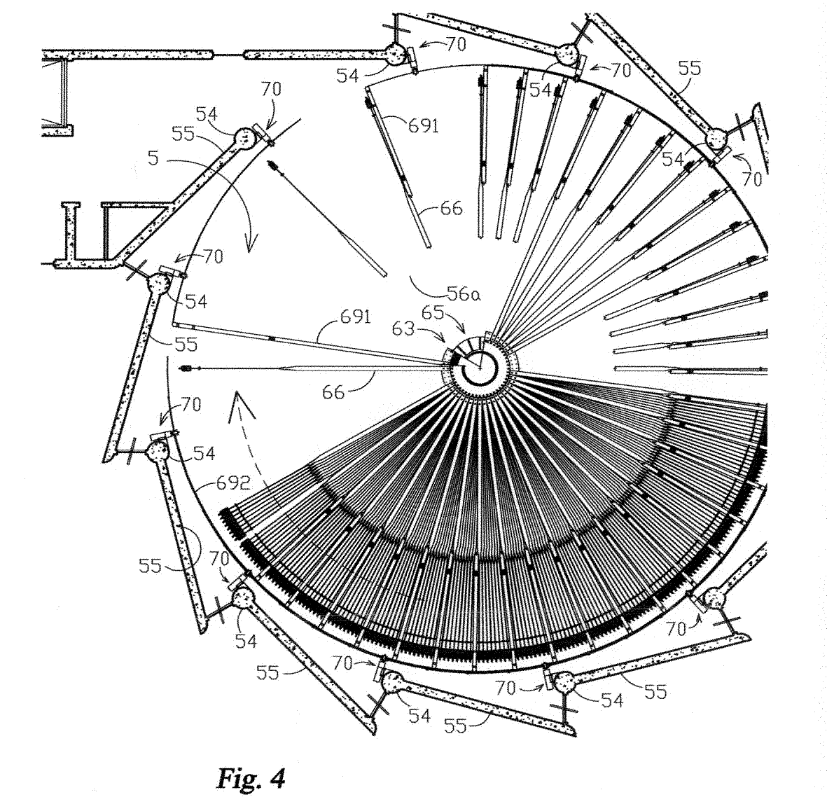

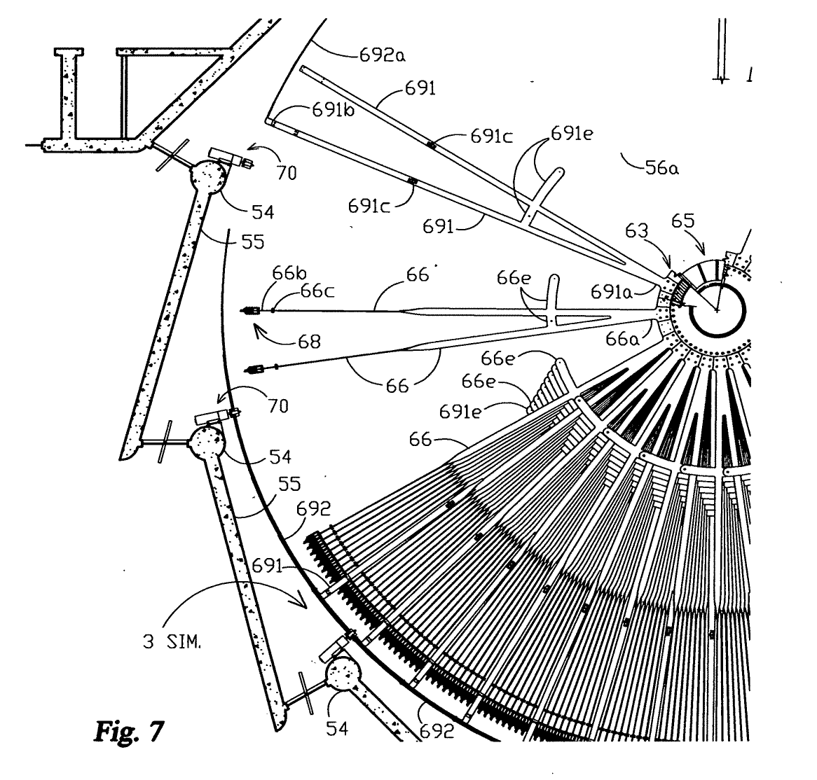

Still from FIG. 9, and also FIGS. 4, 5, 6 and 7, each said lateral lever member is configured with a mountable-end 66a, and oppositely an effort end 66b. Said mountable-end is mounted to the respective hub 632 of the said vertical shaft member 63, and the said effort end 66b is configured with a predetermined high density point mass or high density mass assembly 68, wherein said effort end is disposed to a predetermined effective horizontal path in space about the said vertical axis of rotation.

Another configuration of the said lateral lever member 66 is shown in FIG. 7, wherein two units of said lateral lever members 66 were combined into a common mountable-end 66a, and provided with a bridge 66e, wherein the bridge 66e is connected to the adjacent lever member that all together defined a unitary rotor assembly.

A pie-shaped lateral lever member may be used as well, wherein two or more of the lateral lever members (not shown on drawings) are combined into a unitary lateral lever member having a wider effort end.

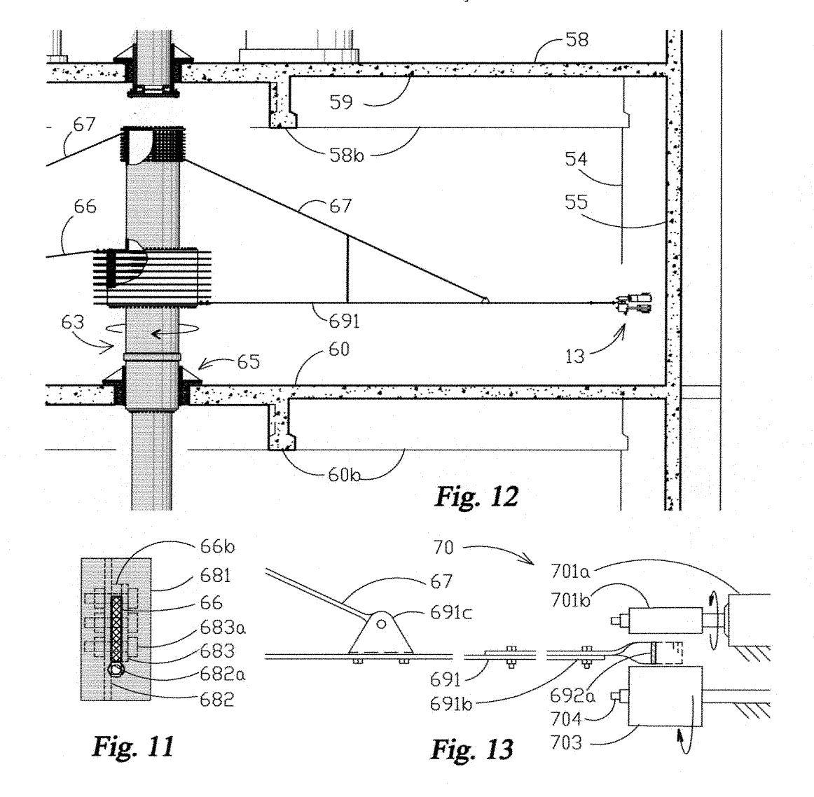

FIGS. 3, 9, 10, 11 and 9, wherein each lateral lever member 66 is equipped with an optional stay member 67 attached to means 66c of the lateral lever member 66, and to means 631a of said vertical shaft member 63, and wherein the stay supports the lateral member vertically into a state of equilibrium.

The stay member comes in different material and/or configuration.

FIGS. 3, 10 and 11, shows a high density mass assembly 68, wherein the respective mass assembly is made in a way that allows reconfiguration on site, in particular, wherein changes to the rotor's load capacity may requires. Said mass assembly comprises a plurality of steel plates 681 fixed by means to the effort end of the lateral lever member 66, and the said means comprises: minding plate 682, integral locking means 682a, supporting block 683, and nuts and bolts 683a.

### An Initiator Drive System

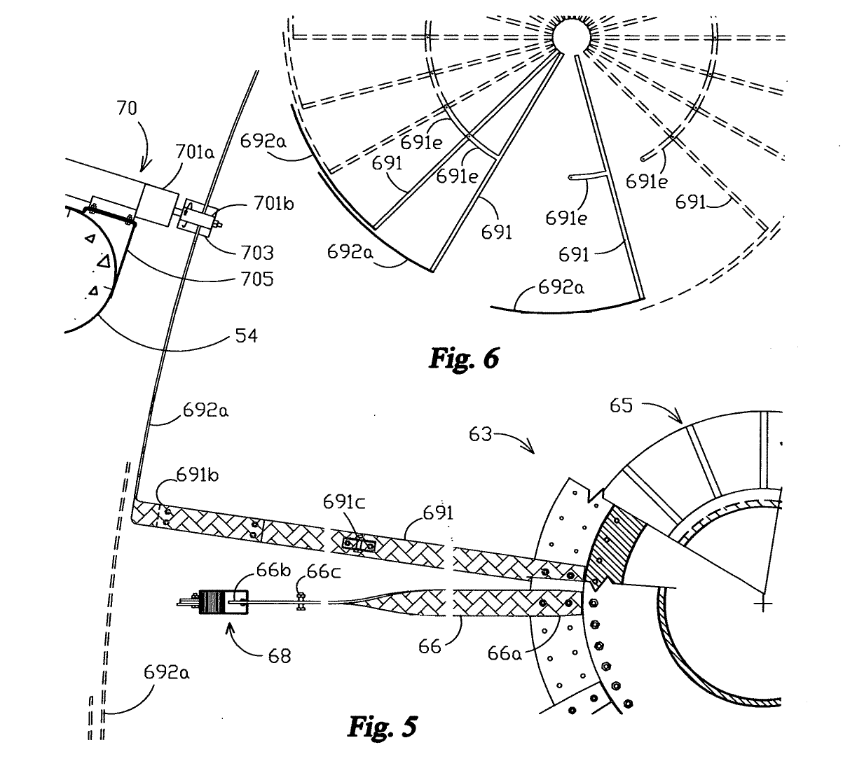

FIGS. 5, 6, 7, 12, 13, 14 and 15, are enlarged partial views of an initiator drive system, comprises: a wheel assembly 69, and a plurality of space apart stationary drive assemblies 70. The stationary drives are attached respectively to the respective column 54, FIG. 4, and are programmed to operate alternately at least with each other or each other group.

A group comprises at least of two equally spaced-apart drive assemblies, which drives the wheel assembly about the vertical axis of rotation while the other groups stay idle, then for time interval other group re-places and so on . . . , and to make sure that the turbine is running non-stop for a predetermined long duration.

FIGS. 3, 4, 5, 12, 13 and 15, wherein the wheel assembly 69 comprises: a plurality of spoke members 691, and rim member 692, wherein each spoke member 691 has a mountable end 691a mounted to the vertical shaft member 63, and the effort end 691b is connected to the rim 692, and wherein the wheel assembly is leveled with and in between the respective group of lever members 66, or mass assemblies 68.

FIGS. 3, 4, 5, 6 and 15, wherein the rim 692 comprises a corresponding number of elongated strips 692a, each said strips has one end attached to the respective spoke member 691 and its long and slender body circumferentially disposed outwardly and over-lapping with the adjacent typical strip member 692a, and wherein the over-lapping strips are held by means 693, which all together defined a unitary wheel assembly 69.

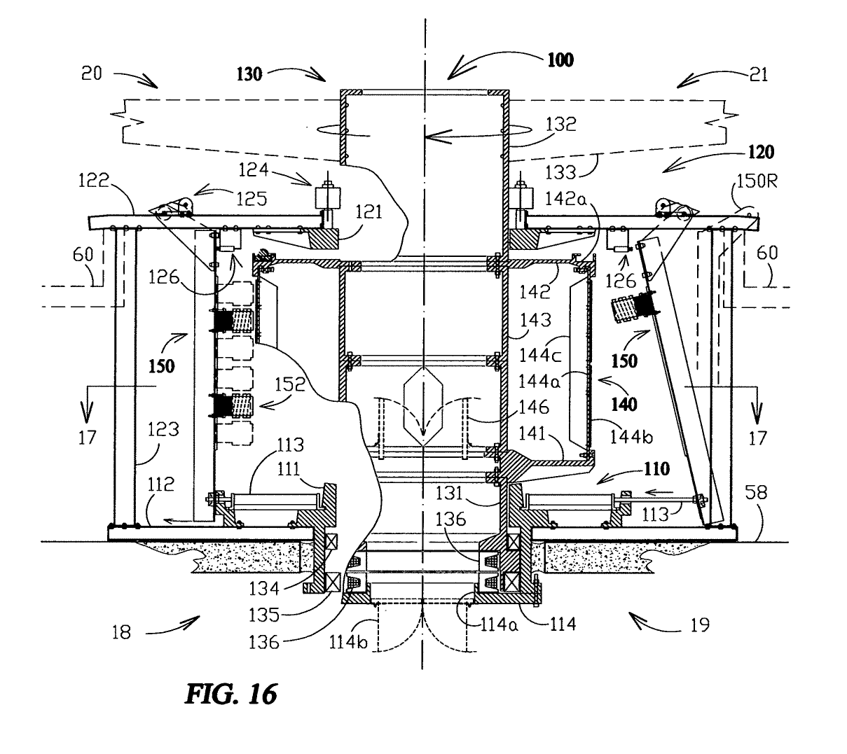

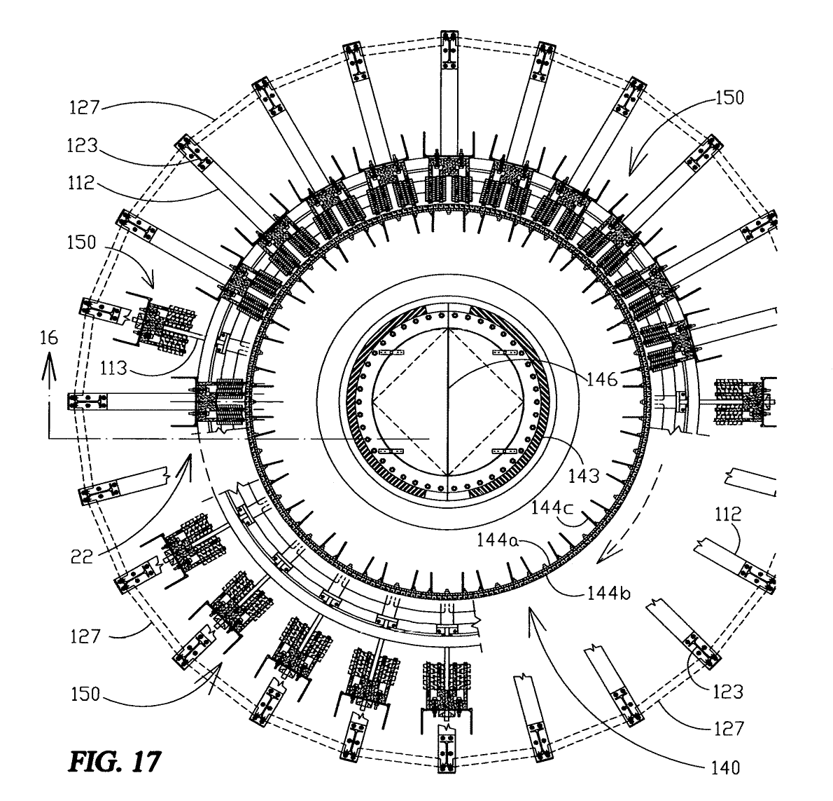

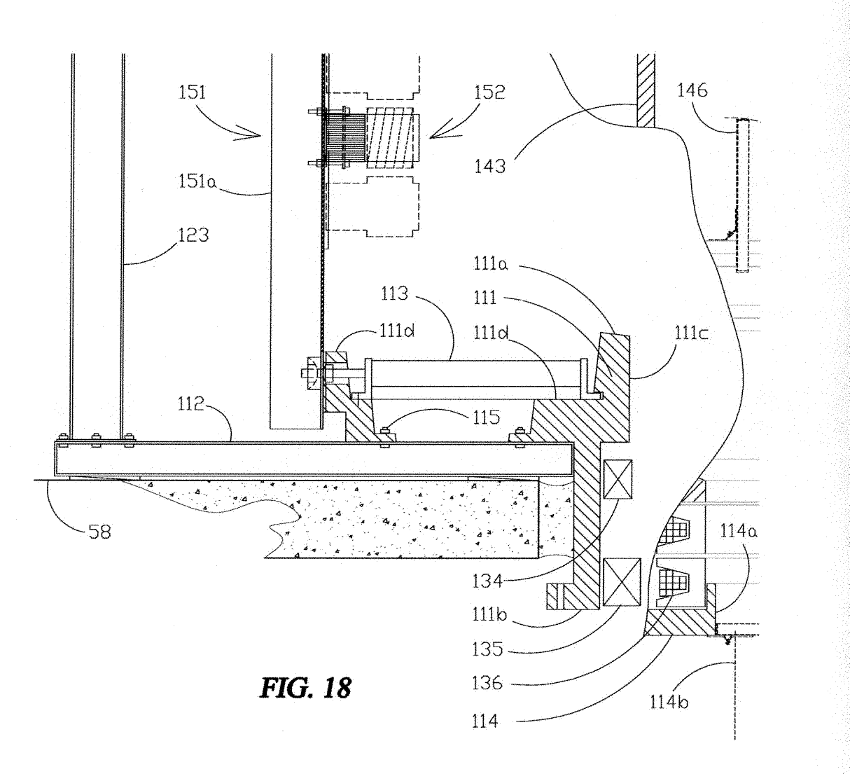

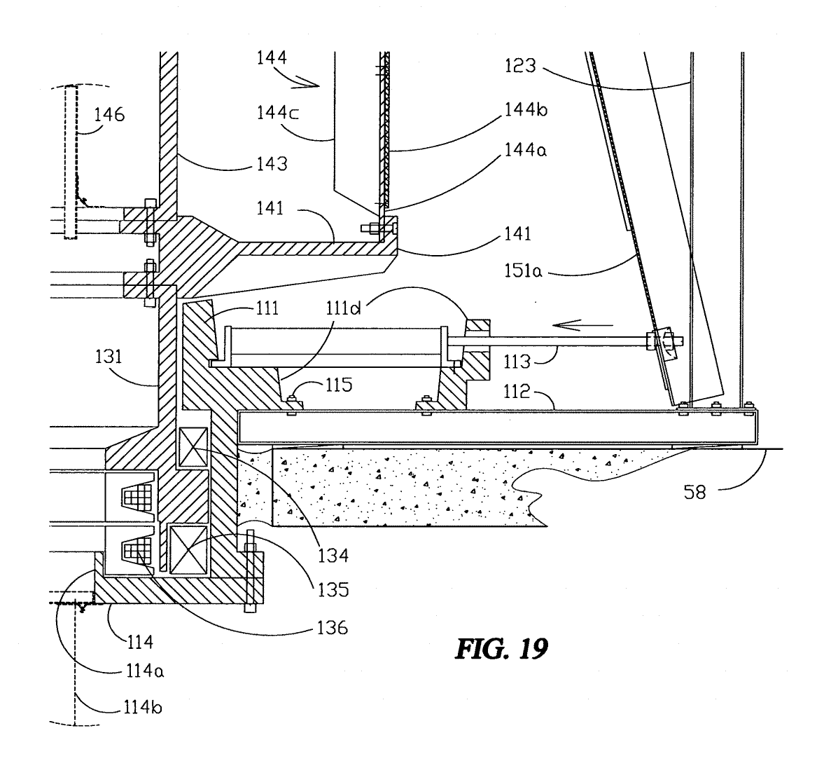

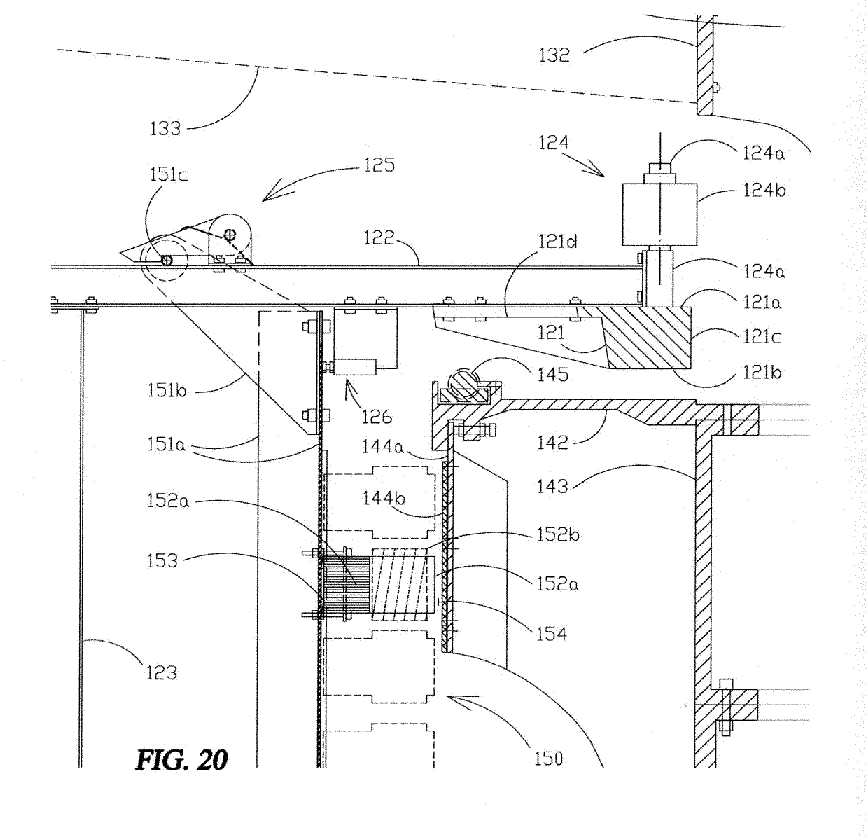

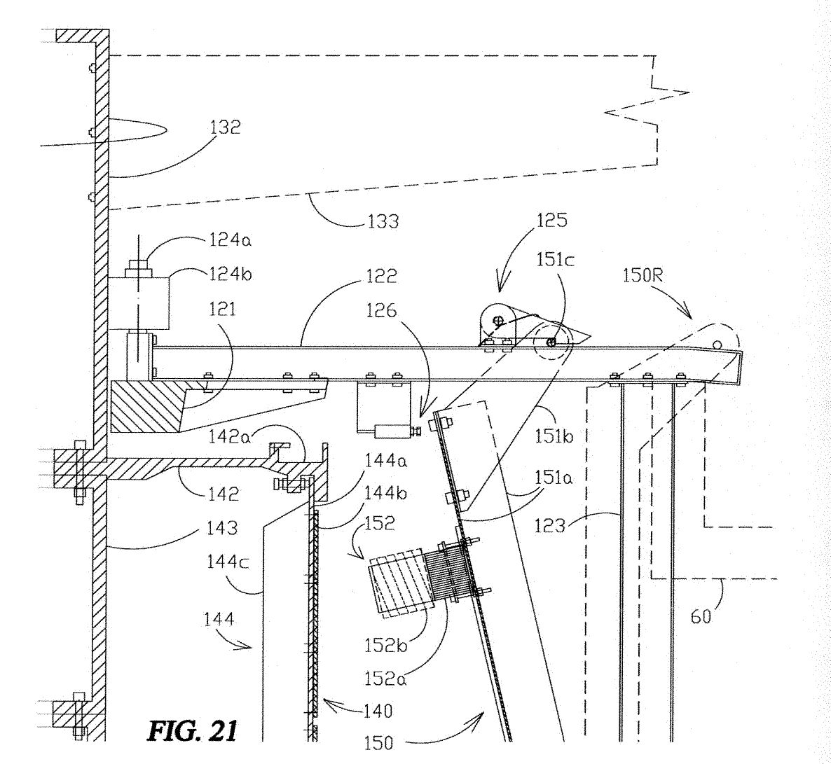

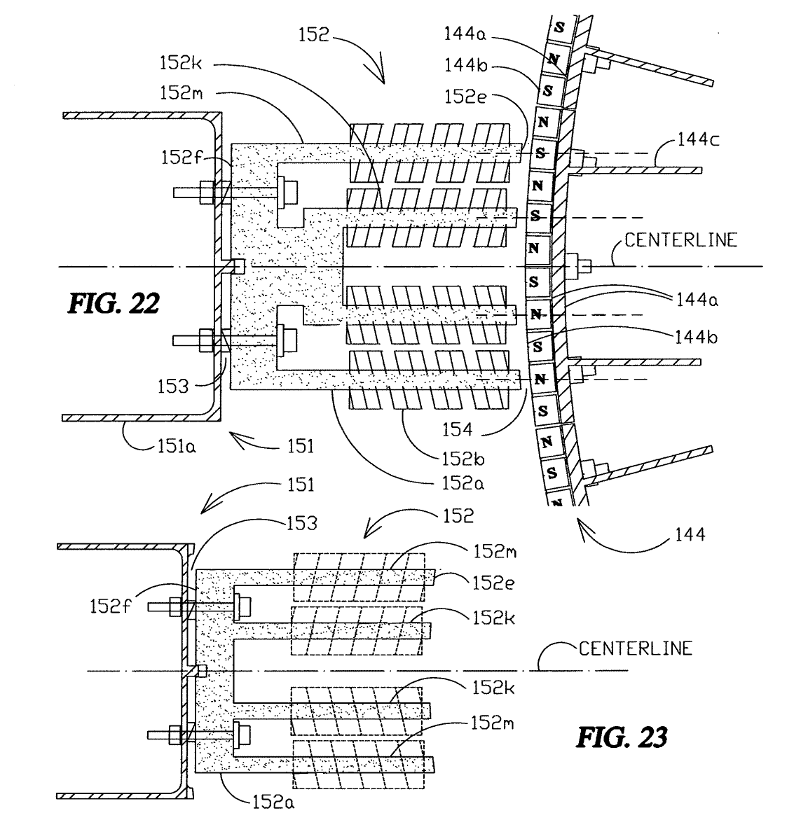

FIGS. 3 and 15 are enlarged partial views of a stationary drives 70, each drive assembly 70 comprises: a small electric motor 701a and an integral roller-drive 701b, wherein the roller-drive 701b is disposed vertically retractable over the rim 692 through a plate 701c, wherein the plate 701c is attached to a stationary mounting means 705, and wherein the mounting means 705 is finally attached at least to the respective column 54.

An idler member 703 is provided through a stationary shaft member 704 supporting the rim member 692, and finally shaft 704 is likewise attached to the means 705.

As mentioned previously, the rim 693 with the respective spoke members 691 are configured leveled with the respective mass assembly 68, and wherein the respective stationary drives 70 drives the wheel assembly 69 about the vertical axis of rotation. In the process the spoke members transfers the forces to the corresponding group of lateral lever members, which finally equates to a torque on the rotating shaft 63 of the said rotor assembly.

### Gearbox Assisted Electric Generator

In one particular configuration, FIGS. 8 and 9, a floor mounted electric generators with appropriate electronic converters were provided, each comprises: a generator 71, a gearbox 72, and the respective drive belt 73. The drive belt 73 transfers the mechanical energy of the rotating vertical shaft 63 to the respective gearbox 72 and generator 71 to generate electricity via a retractable idler member 74.

### Mechanics and Benefits of a Rotor with Exponential Energy Gain

Without going into too much details, the mechanics of the invention in particular, a rotor having a radius of 10.00 m, a peripheral high density point mass of 20,000.00 kg, and normally operating at speed of 30 rpm, are as follows;

where:
A approximate skin area of rotor (areas near the vertical-axis excluded),
a_{fd} acceleration at final displacement in meter per second square,
C drag coefficient—say 2.0,
E_{fv} peripheral output energy at final velocity,
Eᵢ initial output energy,
F_{fv} force required for a rotor to initially accelerates right at the final velocity,
Fᵢ initial input force that uses very little input energy,
J Joule=Newton-meter,
kg kilogram,
MJ Mega-Joules,
m meter,
m_{fb} friction on bearing in equivalent mass—equation (5),
mₚ point mass in kg (mass of levers excluded to simplify the calculations),
mₜ assumed total mass of the rotor including the shaft—say 200,000.00 kg,
μ coefficient of friction on the bearing—say 0.06,
N Newton or Normal force,
Nm Newton-meter,
p air density—say 1.30 kg/m³,
r radius to the center of the (point) mass,
rad radian,
rpm revolution per minute,
s second,
v_{fv} angular velocity at final velocity,
vᵢ initial angular velocity,
½ constant.

$$\begin{matrix}\begin{matrix}{F}_{i} = [ ( {m}_{p} + {m}_{fb} ) ( {v}_{i}^{2} / r ) ] - [ - ( 1 / 2 {CpAv}_{i}^{2} ) ] \\ = [ ( 20 \text{,} 000.00 kg + 1 \text{,} 200.00 kg ) ( {( 0.15 m \text{/} s )}^{2} / 10.00 m ) ] - \\ [ - ( ( 1 / 2 ) ( 2.00 ) ( 1.30 kg \text{/} {m}^{3} ) ( 600 {m}^{2} ) {( 0.15 m \text{/} s )}^{2} ) ] \\ = [ ( 21 \text{,} 200.00 kg ) ( 0.00225 m \text{/} {s}^{2} ) ] - \\ [ - ( ( 1 / 2 ) ( 2.00 ) ( 1.30 kg \text{/} {m}^{3} ) ( 600 {m}^{2} ) ( 0.0225 ) ) ] \\ = 48.70 Nm + 17.60 Nm \\ = 66.00 Nm .\end{matrix} & ( 1 ) \\ \begin{matrix}{E}_{i} = 1 / 2 {m}_{p} {{r}^{2} ( {v}_{i} / r )}^{2} \\ = 1 / 2 ( 20 \text{,} 000.00 kg ) {( 10.00 m )}^{2} {( ( 0.15 m \text{/} s ) / 10.00 m )}^{2} \\ = 1 / 2 ( 20 \text{,} 000.00 ) ( 100.00 ) {( 0.015 rad \text{/} s )}^{2} \\ = 225.00 J .\end{matrix} & ( 2 ) \\ \begin{matrix}{E}_{fv} = 1 / 2 {m}_{p} {{r}^{2} ( {v}_{fv} / r )}^{2} \\ = 1 / 2 ( 20 \text{,} 000.00 kg ) {( 10.00 m )}^{2} {( ( 31.40 m \text{/} s ) / 10.00 m )}^{2} \\ = 1 / 2 ( 20 \text{,} 000.00 ) ( 100.00 ) {( 3.14 rad \text{/} s )}^{2} \\ = 9 \text{,} 860 \text{,} 000.00 J .\end{matrix} & ( 3 ) \\ \begin{matrix}{F}_{fv} = [ ( {m}_{p} + {m}_{fb} ) ( {v}_{fv}^{2} / r ) ] - [ - ( 1 / 2 {CpAv}_{fv}^{2} ) ] \\ = [ ( 20 \text{,} 000.00 kg + 1 \text{,} 200.00 kg ) ( 31.40 m \text{/} {s}^{2} / 10.00 m ) ] - \\ [ - ( ( 1 / 2 ) ( 2.00 ) ( 1.30 kg \text{/} {m}^{3} ) ( 600 {m}^{2} ) {( 31.40 m \text{/} s )}^{2} ) ] \\ = [ ( 21 \text{,} 200.00 kg ) ( 98.60 m \text{/} {s}^{2} ) ] - \\ [ - ( ( 1 / 2 ) ( 2.00 ) ( 1.30 kg \text{/} {m}^{3} ) ( 600 {m}^{2} ) ( 985.96 ) ) ] \\ = 3 \text{,} 716 \text{,} 572.00 Nm + 769 \text{,} 049.00 Nm \\ = 2 \text{,} 859 \text{,} 369.00 Nm .\end{matrix} & ( 4 ) \\ \begin{matrix}{M}_{fb} = [ {μm}_{t} N / r ] / N \\ = [ ( 0.06 ) ( 200 \text{,} 000.00 kg ) ( 9.8 ) / 10.00 m ] / 9.8 \\ = 11 \text{,} 760.00 J / 9.8 \\ = 1 \text{,} 200.00 kg .\end{matrix} & ( 5 )\end{matrix}$$

According to equation (1), the rotor operating at an initial velocity of say 0.15 m/second without load but potential frictions, requires an input force of 66.00 Nm to initiates an acceleration, and the corresponding peripheral output energy is equal to 225.00 J, equation (2).

As expected the output energy is indeed greater than the input energy, which equates to an energy gain of 159.00 J, and that enable the turbine gradually increase its velocity despite driven by relatively very small motors.

Overtime and had the rotor reached its final velocity, the estimated energy output exponentially increased as shown in equation (3). In contrast, the estimated input force for the turbine to accelerate outright from a stand-still state to its desired final velocity is shown in equation (4).

Subtract equations (4) from equation (3) and that equates to a peripheral net force of 7,000,631.00 Nm. Multiply by a radius of 10.00 meters and finally equates to a turbine with exponential energy gain or a rotor having a torque of 70,000 kNm².

According to Newton's Laws of Motion, by doubling the velocity of the turbine—from 30 rpm to 60 rpm, the potential torque increases by four times to 280,000 kNm². And yet in theory, that all derived from an input force of just 66.00 Nm, equation (1).

In practice however, a larger input force is recommend, say a group of 12 equally spaced-apart stationary drives respectively equipped with a motor of say 2 hp connected to a power, and wherein a stronger stationary drive further facilitate the necessity for a large and massive turbine having a longer starting speed—reduced to as short as possible.

### Related Invention

This related invention defined with the rotor configured coaxially to a direct drive generator. In particular, the direct drive generator comprises at least: a vertical-axis armature assembly, and a plurality of vertical segment stator assemblies. Each stator assembly is further configured retractable such that it temporary abrogates the physical phenomenon also known as Lenz's Law while the rotor is at the initial stage of acceleration, thereby it enable the small motor connected to a power . . . drives a very large and massive rotor with ease while at the same time exponentially increases the efficiency.

### Mass Turbine and Direct Drive Generator

FIG. 16 is a cross section of a baseload, fuelless and gearbox-free renewable 100, comprises: a floor pivotal assembly 110, an upper pivotal assembly 120, a rotor with exponential energy gain assembly 130, a vertical-axis armature assembly 140, and a predetermined number of vertical segment stator assemblies 150.

The floor pivotal assembly 110, FIGS. 16, 18 and 19, comprises at least: a pivotal housing 111, and a predetermined number of floor-spreaders 112, and a predetermined number of gas or hydraulic cylinders 113.

The pivotal housing 111 is a rigid member having at least an upper and lower ends 111a, 111b, a vertical axial opening 111c, and an upper flange 111d provided with attachment holes and fixed by means to the floor 58 of said enclosure, and wherein the axial opening 111c is aligned coaxially with the predetermined said vertical axis of rotation.

Each floor-spreader 112 is an elongate rigid member having a central and peripheral ends fixed by nuts and bolts 115 radially to the respective attachment holes of the pivotal housing 111, thereby created a stator-space to accommodate the said segment stator assembly 150.

Each cylinder 113 is attached by nuts and bolts to the respective attachment holes of the pivotal housing 111 to accommodate the retractable said segment stator assembly 150.

A predetermined space is required below floor 58, FIG. 16.

The lower end 111b FIG. 18, of the pivotal housing 111 is provided with a removable supporting plate 114 attached by nuts and bolts. The supporting plate 114 has an access opening 114a providing access for a person working at the interior of the generator during and as required after the installation. The supporting plate 114, as desired, is provided with a pair of shutter 114b.

The upper pivotal assembly 120, FIGS. 16, 20 and 21, comprises: a pivotal housing 121, a predetermined number of upper-spreaders 122, and a predetermined number of stator-uprights 123.

FIGS. 16, 20 and 21, the pivotal housing 121 is as a rigid member having an upper and lower faces 121a, 121b, a vertical axial opening 121c, and a flange 121d equipped with attachment holes, and wherein the pivotal housing 121 is aligned coaxially with the pivotal housing 111 of said floor pivotal assembly 110.

Each stator-upright 123 is as an elongated rigid member having lower and upper flanges, wherein the lower flange is fixed by nuts and bolts to the respective floor-spreader 112 of said pivotal floor assembly 110.

Each upper-spreader 122 is an elongated rigid member having a central and peripheral ends, wherein the central end is fixed by nuts and bolts radially to the respective said attachment holes of the pivotal housing 121 and the peripheral end is fixed by nuts and bolts to the upper flange of the stator-upright 123.

The said upper pivotal assembly 120 is configured with a predetermined number of bearing assemblies 124. Each bearing assembly comprises: a pivotal shaft 124a and wheel bearing 124b. The pivotal shaft 124a is fixed by nuts and bolts at least to the central end of the respective upper-spreader 122, which makes the construction relatively simple.

Further, each upper-spreader 122 is configured with holding means comprises at least: a latch assembly 125, and an adjustable stop assembly 126, which together holds the respective said vertical segment stator assembly 150 securely hanging on said upper-spreader 122 and defined the air gap 154 with respect to said vertical-axis armature assembly 140.

The peripheral end of the upper-spreader 122 is fixed by means to the stator-upright 123 and unitary supporting the pivotal housing 121 a predetermined height from the floor-spreader 112 of said floor pivotal assembly 110.

Alternately it is within the scope of the invention that the peripheral end of the upper-spreader 122 is fixed to the intermediate floor 60 of the said enclosure.

A space is created in between said upper pivotal assembly 120 and said floor pivotal assembly 110, to accommodate the said vertical-axis armature assembly 140 and said vertical segment stator assembly 150.

FIG. 17, optional upright-panels 127 are respectively fixed in between respective stator-uprights 123, which enclosed, stabilized and aligned the said upper pivotal assembly 120 and said floor pivotal assembly 110 to each other.

In other configuration, the stator-uprights 123 and upright-panels 127 are replaced (not shown) by a concrete wall supporting the said upper-spreader 122. Another alternative means is wherein the stator-uprights 123 and upright-panels 127 are replaced by a concrete wall supporting the said upper-spreader 122, and wherein the concrete wall and said floor pivotal assembly 110 are embedded below the ground.

A predetermined space is required above said upper pivotal assembly 120 to accommodate said rotor with exponential energy gain assembly 130, FIG. 16.

The rotor with exponential energy gain assembly 130, FIGS. 16, 19, 20 and 21, wherein the original rotor comprising: a vertical shaft member 63 and a plurality of lateral lever members 66 has been upgraded, in particular, wherein the new vertical shaft member is configured into segments comprises: a lower shaft segment 131, at least one upper shaft segment 132, which are both configured coaxially with said vertical-axis armature assembly 140.

A lower shaft segment 131 is a rigid hollow vertical cylinder member having at least an upper and lower ends and held pivotal by said floor pivotal assembly 110. The upper end is configured with a flange while the lower end is configured according to the type of bearing employed.

In one particular embodiment, FIGS. 16, 18 and 19, a ball bearing 134 is installed in between the pivotal housing 111 and the lower shaft segment 131, a roller bearing 135 is installed between the bottom end of the shaft 131 and the supporting plate 114 of said floor pivotal assembly 110, and an optional pair of electromagnetic bearing 136 is installed in order to release the vertical load from the roller bearing 135 once the bearing 136 is energized.

The bearings are serviced by releasing the supporting plate 114, which are held by nuts and bolts with respect to the pivotal housing 111 of said floor pivotal assembly 110.

FIGS. 16, 20 and 21, the upper shaft segment 132 is a rigid vertical hollow cylinder of a predetermined length, having upper and lower ends; wherein the upper shaft segment 132 is held pivotal by said upper pivotal assembly 120 and aligned coaxially with the lower shaft segment 131, and wherein the upper end of the shaft segment 132 is extended in space above the upper pivotal assembly 120 supporting the lateral lever member 133.

FIGS. 16, 20 and 21, plurality of lateral lever members 133 also known as member 66 were laterally provided and respectively mounted by nuts and bolts to the said upper shaft segment 132, and wherein the lateral lever members 133 are driven by the said Initiator Drive System about the said vertical axis of rotation.

An armature-space is created in between the lower shaft segment 131 and upper shaft segment 132, to accommodate the said vertical-axis armature assembly 140.

The vertical-axis armature assembly 140, FIGS. 16, 19, 20 and 21, comprises: a lower disk 141, an upper disk 142, preferably one intermediate shaft segment 143, and preferably a plurality of segmental element assemblies 144.

FIGS. 16 and 19, a lower disk 141 is a rigid circular member of a predetermined radius having at least upper and lower faces, a vertical central axis, and various attachment holes, wherein the lower disk 141 is fixed by nuts and bolts coaxially to the upper end of the lower shaft segment 131 of said rotor with exponential energy gain assembly 130.

FIGS. 16, 20 and 21, the upper disk 142 is a rigid circular member of a predetermined radius having at least an upper and lower faces, a vertical central axis, and various attachment holes, wherein the upper disk 142 is fixed by nuts and bolts coaxially to the lower end of the upper shaft segment 132 of said rotor with exponential energy gain assembly 130.

Further, the upper disk 142 is configured with an optional peripheral channel 142a to accommodate a pair of movable damper assemblies 145. Each damper assembly 145 is held movable by means along the channel 142a while dynamically balancing the said rotor assembly 130 at least during the installation.

A space is created in between the lower disk 141 and upper disk 142, to accommodate the said segmental element assemblies 144.

An intermediate shaft segment 143 is fixed in between the lower disk 142 and the upper disk 142 of the said vertical-axis armature assembly 140 which structurally transfers the vertical load of the said rotor with exponential energy gain assembly 130 directly down to the pivotal housing 111 of said floor pivotal assembly 110.

The plurality of said segmental element assemblies 144 are provided, FIGS. 16, 17, 19, 21 and 22, each element assembly 144 comprises: an element housing 144a, a predetermined number of magnetic elements 144b, and preferably a predetermined number of vertical stiffeners 144c.

The element housing 144a is a rigid member of a predetermined radius having an outside and inside faces, a lower and upper ends, and various attachment holes. The outside face is defined by a predetermined radius measured from the vertical axis of rotation, and wherein the element housing 144a is provided with a predetermined number of vertically elongated magnetic elements 144b also known as the magnetic poles.

The magnetic elements 144b, FIG. 22, are at least made of permanent magnets respectively of a predetermined width, thickness and length, wherein each magnetic element is vertically elongated and fixed by means to the outside face of the element housing 144a, wherein the magnetic elements 144b are arranged alternately one after the other with respect to its designated north and south pole marked N and S respectively.

The magnetic elements 144b are either permanent magnets or electromagnets. Electromagnets are generally employed (not shown) wherein the generator under consideration is a synchronous generator.

The lower end of the element assembly 144 is fixed by nuts and bolts to the lower disk 141 while the upper end is fixed to the upper disk 142.

It is also within the scope of the invention that the element housing 144a of the said vertical-axis armature assembly 140 is configured as a singular member of a predetermined length and vertically extended in space supporting the said lateral lever member 133.

A stator-space is created in between the outside face of the element assembly 144 and the respective stator-upright 123 to accommodate the respective retractable said vertical segment stator assembly 150.

A platform and a pair of shutter 146 are attached to the lower disk 141 to facilitate the installation. Access from the inside of the shaft segment 143 to the inside face of the respective element housing 144a is provided as well.

Also defined is a self-sustaining armature assembly and also known as a self-sustaining energy storage module, which the industry will find it cost effective and sustainable in the construction of generator of a different stator configuration; wherein at least the said vertical-axis armature assembly 140 is configured coaxially and directly without the gearbox with the said rotor with exponential energy gain 130; and wherein the said armature assembly is held pivotal by means attached to a suitable floor about the vertical axis of rotation.

Further defined is a self-sustaining armature assembly, wherein in reverse the upper shaft segment 132 is held pivotal by means attached to a suitable floor, wherein the lower end of the upper shaft segment 132 is extended in space a predetermined length at least below the floor 58 and appropriately supporting the lateral lever member 133, and wherein the upper end of the upper segment 132 is extended in space above floor 58 and fixed coaxially to said vertical-axis armature assembly 140.

The plurality of vertical segment stator assemblies 150, FIGS. 16 to 21, wherein each said vertical segment stator assembly 150 is preferably attached by means to said upper pivotal assembly 120, and maintained a predetermined distance from the outside face of the magnetic elements 144b known as the air gap 154, and wherein said vertical segment stator assembly 150 comprises: a mounting rail assembly 151, and plurality of inductor assemblies 152.

The mounting rail assembly 151 FIG. 20, further comprises: a mounting rail 151a equipped with a supporting means 151b.

FIGS. 16 to 21, the mounting rail 151a is an elongated rigid member of a predetermined width and length, having an upper and lower ends, a predetermined mounting holes, and strong enough to withstand the magnetic flux with respect to the said vertical-axis armature assembly 140, and wherein the at least lower end of the said rail 151a is attached to the retractable cylinder 113 of the at least said floor pivotal assembly 110.

The supporting means 151b is a pair of arms disposed respectively on both side of the respective upper-spreader 122 respectively with a lower and upper ends, wherein both lower ends of are fixed by nuts and bolts to the upper portion of the mounting rail 151a and both the upper ends are extended upwardly and passed beyond the upper-spreader 122 of said upper pivotal assembly 120 which accommodate the supporting rod 151c.

The supporting rod 151c is held releasable by the latch assembly 125 of the respective upper-spreader 122.

Other configuration of a mounting rail assembly 151 may be employed as will. It is also within the scope of the invention that the mounting rail 151a is configured closer to the air gap or at least little bit behind the front 152e of the iron core 152a, and correspondingly moved the respective winding 152b to the outer side of the mounting rail 151a. Such a configuration makes the said segment stator 150 much stable with respect to the magnetic flux of the rotating said vertical-axis armature assembly 140.

The latch assembly 125 is spring assisted, which enable the said vertical segment stator assembly 150 or (150R in dotted lines) easily released as it moves back and forth along the upper-spreader 122 of said upper pivotal assembly 120, at least during the installation.

The inductor assembly 152, FIGS. 16, 17, 20, 21 and 22, comprises: an iron core 152a, and wire coils 152b, and wherein the inductor assembly defined having a top 152c, bottom 152d, front 152e, back 152f and two sides 152g and 152h. The assembly is attached by means at least having the back 152f against the mounting rail 151a. FIG. 22, the spacer-space 153 is created in between the mounting rail 151a and back 152f of the inductor assembly 152 to provide a means for an effective air gap 154 gets finally calibrated on site.

FIGS. 17 and 22, an iron core 152a is a U-shaped iron core having two legs 152k and 152m respectively on both sides of the iron core with respect to the radially defined centerline of said segment stator assembly 150, wherein both legs 152k and 152m on one side of the iron core are aligned to the respective magnetic element marked S (south polarity) and the space in between legs is aligned to a magnetic element marked N (north polarity), while on the other side of the iron core, both legs 152k and 152m are aligned to the respective magnetic element marked N (north polarity) and the space in between legs is aligned to the magnetic element marked S (south polarity) of the armature assembly 140.

In practice, the more the number of legs there is on the iron core 152a, potentially the more the number of turns on the winding 152b, leading to a much stronger inductor. In addition, a wider stator-space is provided to accommodate for a potentially much longer inductor assembly 152.

The configuration of the iron core 152a is subject to changes and limited only by the scope of the invention. FIG. 23 is a simplified iron core configuration and also with two legs on both sides of the iron core. Another configuration (not shown) is a simple U-shaped iron core with only one leg on both sides.

The inductor assembly 152 comes in various phase configurations (not shown) in order for said segment stator assembly 150 to generate at least a three phase power output, this is done by moving the inductor assembly 152 a predetermined distant off the said centerline of respective said segment stator assembly 150 such that the respective frequencies are 120 degrees apart.

FIGS. 22 and 23, a wire coils 152b also known as winding are fixed to the respective legs of the iron core 152a and connected electrically to generate an alternating current induced by a rotating said vertical-axis armature assembly 140, and wherein the current reverses its direction every time the armature assembly 140 rotates one magnetic element 144b passed forward.

By comparison, a direct drive generator requires a large number of magnetic elements 144b to compensate for the speed, which in perspective, is similar to the generator employed in the hydroelectric power station.

FIG. 22, the air gap 154 defined as the space in between the front 152e of the respective inductor assembly 152 and the face of the magnetic element 144b of the element assembly 144. Although the thickness of the air gap 154 is predetermined in the factory, in addition, it is beneficial that a more calibrated and efficient air gap is finally configured on site during the installation, and wherein the spacers 153 are provided as required.

Said vertical segment stator assembly 150 is provided with a predetermined number of inductor assemblies 152, and wherein said assembly 150 is electrically connected to generate the desired power output induced by the rotating said vertical-axis armature assembly 140.

FIGS. 16, 20 and 21 said stator assembly 150 is preferably provided with at least three inductor assemblies 152 respectively of a different phase configuration, namely: the first phase, the second phase and the third phase, and wherein said stator assembly 150 is electrically connected to generate a unitary three phase power output induced by the rotating said armature assembly 140.

FIG. 17, a predetermined number of said stator assemblies 150 are provided, wherein each said stator assembly 150 is connected electrically as a unitary generator and respectively able to generate electricity induced by the rotating said armature assembly 140 or a predetermined number of said stator assemblies 150 are provided, wherein at least two of said stator assemblies 150 are connected electrically as a unitary generator and collectively able to generate electricity induced by the rotating said vertical-axis armature assembly 140.

FIGS. 16, 17, 19 and 21, said stator assembly 150 is configured retractable, which at least temporary abrogates the physical phenomenon also known as Lenz's Law while the turbine is at the initial stage of acceleration.

It is also within the scope of the invention that the said vertical segment stator assembly 150 is configured stationary and fixed by means to the at least said floor pivotal assembly 110 and upper pivotal assembly 120.

Another advantageous feature of the said segment stator assembly 150 is that the traditionally monolithic, large, heavy and static stator had evolved into a segmental and modular, which is relatively easy to manufacture, transport, install and upgrade—particularly, its power capacity relative to future demand.

As shown and described what I claim is:

1. A mass turbine and direct drive generator comprising:
a floor pivotal assembly;
an upper pivotal assembly;
a rotor with exponential energy gain assembly;
a vertical-axis armature assembly; and
at least one segment stator assembly.
said floor pivotal assembly, comprising at least:
a pivotal housing;
at least one stator-space;
said pivotal housing is at least a member having upper and lower ends and configured with a vertical axial opening, wherein the pivotal housing attached by means at least to a suitable floor, and wherein the vertical axial opening coaxially aligned with the predetermined vertical axis of rotation;
said stator-space created a predetermined distance from the vertical axis of rotation;
said upper pivotal assembly comprising:
at least one stator-upright;
at least one upper-spreader;
a pivotal housing;
an armature-space;
said stator-upright is at least an elongated member of a predetermined height having lower and upper ends, and wherein the lower end fixed by means to the at least suitable floor a predetermined distance from the vertical axis of rotation;
said upper-spreader is at least an elongated member of a predetermined length with central and peripheral ends, wherein the peripheral end fixed by means to the at least upper end of the stator-upright, and wherein the central end fixed by means to the pivotal housing;
said pivotal housing is at least a circular member of a predetermined diameter and height having upper and lower faces and configured with a vertical axial opening, wherein the vertical axial opening coaxially aligned with the pivotal housing of the said floor pivotal assembly;
said armature-space created in between the said upper pivotal assembly and the said floor pivotal assembly;
a predetermined space created above the upper pivotal assembly;
said rotor with exponential energy gain assembly comprising:
at least one upper shaft segment;
at least one lateral lever member;
said upper shaft segment is at least a vertical cylinder of a predetermined diameter and height having upper and lower ends and held coaxially pivotal by the said upper pivotal assembly and wherein the upper end extended in space a predetermined height above the said upper pivotal assembly;
said lateral lever member is at least an elongated member of a predetermined length having mountable and effort ends, wherein the mountable end fixed by means to the upper shaft segment and the effort end configured with a predetermined high-density mass, wherein the high-density mass disposed to a predetermined effective horizontal path in space about the vertical axis of rotation, and wherein the high-density mass enable the said rotor with exponential energy gain assembly generates output energy greater than the required input energy per unit of velocity;
said vertical-axis armature assembly comprising:
at least one element assembly;
said element assembly comprising:
at least one element housing;
a predetermined number of magnetic element;
said element housing is at least a cylindrical member of a predetermined height and having outside face, lower and upper ends, wherein the outside face defined by a predetermined radius measured from the vertical axis of rotation, wherein the lower end coaxially configured pivotal with means to the said floor pivotal assembly and the upper end coaxially configured fixed with means to the said rotor with exponential energy gain assembly;
said magnetic elements are at least permanent magnets respectively of a predetermined width, thickness, and height, wherein each magnetic element fixed by means to the outside face of the element housing alternately arranged one after the other about its designated south and north poles;
said vertical segment stator assembly comprising:
a mounting rail assembly;
at least one inductor assembly;
said mounting rail assembly comprising:
a mounting rail;
said mounting rail is at least a member of a predetermined depth, width, and height defined by upper and lower ends, and strong enough to withstand the magnetic flux concerning the said vertical-axis armature assembly, and wherein the at least upper end attached with means to the said upper pivotal assembly;
said inductor assembly attached with means to the mounting rail assembly, wherein the front of the inductor assembly maintained a predetermined air gap with the magnetic elements of the said vertical-axis armature assembly, and wherein the inductor assembly comprising:
an iron core;
at least one wire coil;
said iron core is at least a U-shaped iron core having at least one leg on one side and at least one leg on the other side of the radially defined centerline of the said stator assembly;
said wire coil also is known as winding attached to the at least one leg of the iron core and connected electrically to generate at least an alternating current induced by the rotating said vertical-axis armature assembly.

2. A mass turbine which coaxially configured to a direct drive generator and enables to generate output energy greater than the required input energy per unit of velocity, comprising at least:
a vertical shaft member;
at least one lateral lever member;
said vertical shaft member is at least a vertical cylinder of a predetermined diameter and height having upper and lower ends and held pivotal by means about the vertical axis of rotation, wherein the upper end extended in space a predetermined height above the pivotal means and supporting the said lateral lever member;
said lateral lever member is at least an elongated member of a predetermined length having at least an effort end, wherein the effort end configured with a predetermined high-density mass, wherein the high-density mass disposed to a predetermined effective horizontal path in space about the vertical axis of rotation, and wherein the high-density mass enable the said mass turbine generates output energy greater than the required input energy per unit of velocity.

3. The mass turbine and direct drive generator of claim 1, wherein the said floor pivotal assembly provided with a predetermined number of floor-spreaders, wherein each floor-spreader is at least an elongated member of a predetermined length and having a central and peripheral ends, wherein the central end fixed by means to the at least pivotal housing of said floor pivotal assembly, and wherein the peripheral end fixed by means at least to the floor.

4. The mass turbine and direct drive generator of claim 1, wherein the stator assembly retracted by means that temporarily prevent the inductive coupling and at least reducing the resistance between stator assembly and armature assembly during the initial stage of the operation.

5. The mass turbine and direct drive generator of claim 1, wherein the mounting rail of the respective said segment stator assembly held stationary, and wherein the upper end fixed by means to the said upper pivotal assembly and the lower end fixed by means to the said floor pivotal assembly.

6. The mass turbine and direct drive generator of claim 1, wherein the said U-shaped iron core defined with at least two pairs of legs, wherein one pair of legs on one side and another pair of legs on the other side in reference to the radially defined centerline of said stator assembly, wherein each respective pair of legs separated by space, wherein both legs on one side of the iron core aligned to the respective magnetic element marked ‘S’ and the space in between legs aligned to a magnetic element marked ‘N’, wherein on the other side of the iron core both legs aligned to the respective magnetic element marked ‘N’ and the space in between legs aligned to the magnetic element marked ‘S’, as shown in FIG. 22.

7. The mass turbine and direct drive generator of claim 1, wherein the element housing and the said vertical shaft member instead configured as one integral piece member and held pivotal by means.

8. The mass turbine and direct drive generator of claim 1, wherein the lateral lever member of the said rotor with exponential energy gain assembly defined a wheel of a predetermined diameter, wherein the wheel having central mountable means and peripheral high-density mass, wherein the central mountable means fixed to the said upper shaft segment of the said rotor with exponential energy gain assembly, wherein the high-density mass also known as high-density rim concentrically disposed to an effective horizontal path in space about the vertical axis of rotation, and wherein the high-density mass enable the said rotor with exponential energy gain assembly generates output energy greater than the required input energy per unit of velocity.

9. A self-sustaining armature assembly, which the industry may find it cost effective as well as sustainable in the construction of generator of a different stator configuration, comprising at least;
a vertical shaft member;
an element housing;
a predetermined number of magnetic elements;
at least one lateral lever member;
said vertical shaft segment is at least a vertical cylinder of a predetermined diameter and height having upper and lower ends and held pivotal with means, wherein the pivotal means attached to the at least suitable floor coaxially with the vertical axis of rotation, wherein the upper end extended in space at a predetermined height above the pivotal means and supporting the said lateral lever member, wherein the lower end extended in space a predetermined length below the pivotal means;
said element housing is at least a cylindrical member of a predetermined diameter and height having outside face and lower and upper ends, wherein the upper end at least coaxially configured fixed with the said vertical shaft member;
said magnetic elements are at least made of permanent magnets respectively of a predetermined width, thickness, and height, wherein each magnetic element fixed by means to the outside face of the said element housing, wherein the magnetic elements alternately arranged one after the other about its designated south and north poles;
said lateral lever member is at least an elongated member of a predetermined length having at least an effort end, wherein the effort end configured with a predetermined high-density mass, wherein the high-density mass disposed to a predetermined effective horizontal path in space about the vertical axis of rotation, and wherein the high-density mass enable the said self-sustaining armature assembly generates an output energy exponentially greater than the required input energy per unit of velocity.

10. The self-sustaining armature assembly of claim 9, wherein in a reversed configuration the lower end of the vertical shaft member extended in space below the pivotal means and supporting the lateral lever member, wherein the upper end extended in space a predetermined height above the pivotal means and coaxially configured with the magnetic elements.
